(19) United States
(12) Patent Application Publication
(10) Pub. No.: US 2014/0236643 A1
(43) Pub. Date: Aug. 21, 2014

(54) COMPUTER PROGRAM, METHOD, AND SYSTEM FOR PROPERTY MANAGEMENT

(71) Applicant: Lodge Tools, Inc., Olathe, KS (US)

(72) Inventors: Kent B. Comfort, Kansas City, MO (US); Ravi K. Bhaskar, Kansas City, MO (US)

(73) Assignee: Lodge Tools, Inc., Olathe, KS (US)

(21) Appl. No.: 14/182,692

(22) Filed: Feb. 18, 2014

Related U.S. Application Data
(60) Provisional application No. 61/765,951, filed on Feb. 18, 2013.

(51) Int. Cl. G06Q 50/12; G06Q 10/02; G06F 3/0484

(52) U.S. Cl. CPC G06Q 50/12; G06F 3/0484; G06Q 10/02
USPC 705/5

(57) ABSTRACT

A computer program, method, and system for managing at least one property provide a graphical user interface that contemporaneously displays a calendar and a plurality of room demarcations. The calendar displays a selected portion of time periods via a plurality of calendar demarcations and a numerical indication of occupancy status for each time period. The plurality of room demarcations corresponds to rooms of the property, and each room demarcation contains a plurality of items of room information represented by a coded identifier. Certain statistical information, such as the average daily rate (ADR) of rooms of the property or the revenue per available room (REVPAR), is provided in real time and based on a most recent information stored by the computer program. A property manager can set goals for ADR/REVPAR and use the real time ADR/REVPAR information to modify future ADR/REVPAR values to obtain or reach the set goals.

### RELATED APPLICATION

This non-provisional patent application claims priority benefit, with regard to all common subject matter, of earlier-filed U.S. Provisional Patent Application No. 61/765,951, filed Feb. 18, 2013, and entitled “COMPUTER PROGRAM, METHOD, AND SYSTEM FOR PROPERTY MANAGEMENT.” The identified earlier-filed provisional patent application is hereby incorporated by reference in its entirety into the present application.

### BACKGROUND

1. Field

Embodiments of the invention relate to a computer program, method, and system for property management. In more detail, embodiments of the invention are directed to a computer program, method, and system for allowing users to manage guest lodging properties, such as motels, hotels, time-shares, resorts, chateaus, lodges, condominiums, cottages, or the like.

2. Related Art

Property management software for the lodging and/or hospitability industry generally facilitates management of properties, equipment, personnel, and/or maintenance. Currently available property management software generally includes complicated and unintuitive user interfaces that require frequent updates, such that users must expend significant amounts of time and training before they become efficient in using the software. The complexity of currently available property management software also obfuscates statistical information that is required for the property to be successful in the short term and long term. In addition, the cost of property management software may be prohibitively expensive, thus excluding small, privately owned properties from the use of such software. Further, current property management software may be proficient at performing individual functions, such as facilitating reservations or tracking maintenance requirements; however, such software generally require cumbersome navigation and the necessity of opening many screens to complete required guest service functions.

### SUMMARY

In accordance with a first embodiment of the invention, a graphical user interface provided by a computer program for property management and for managing at least one property contemporaneously displays interface elements including a calendar and a plurality of room demarcations. The calendar displays at least one calendar demarcation and one or more numerical indications of occupancy status proximal to each calendar demarcation. Each calendar demarcation represents a time period and each numerical indication represents the total occupancy of the property for that time period. The location of each numerical indication and the appearance of each calendar demarcation quickly conveys the occupancy for each time period to users of the system. Each of the plurality of room demarcations represents a room of the property. Users of the system can readily determine various pieces of information about each room by looking at a plurality of items of room information represented by a coded identifier displayed for each corresponding room demarcation.

In accordance with a second embodiment of the invention, a computer program and method for managing at least one property comprises providing a graphical user interface that contemporaneously displays a calendar, a plurality of room demarcations, and at least one statistic. The calendar displays a selected portion of time periods via a plurality of calendar demarcations and a numerical indication of occupancy status for each time period. The plurality of room demarcations corresponds to rooms of the property, and each room demarcation contains a plurality of items of room information represented by a coded identifier. The method generates the statistic based on a set of information a user would like to know about the overall success of the property and the statistic is displayed in a prominent place on the GUI. When a user of the computer program looks at each calendar demarcation and numerical indication, the occupancy of the property will be quickly determined. When the user glances over each room demarcation, the conciseness of the coded identifier helps the user determine information about each room. And when the user looks at the statistic, more comprehensive information about the overall condition of the property is conveyed.

In accordance with a third embodiment of the invention, a computer program and method that provides a graphical user interface contemporaneously displays a calendar, a first plurality of room demarcations representing rooms of a first property, and at least one statistic. Information about each room of the first property is intuitively conveyed by one of the first plurality of room demarcations. The graphical user interface also contemporaneously displays a second plurality of room demarcations representing rooms of a second property. Information about each room of the second property is intuitively conveyed by one of the second plurality of room demarcations. The statistic as defined by the user provides information relating to the success of the first property, the second property, or both properties. The contemporaneousness of the information displayed by the computer program allows a user to quickly review the first plurality of room demarcations, the second plurality of room demarcations, and the statistic. The information conveyed can be used to determine if changes to rooms of the first and second property will increase the success of the first property, the second property, or both properties.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a system diagram of an embodiment of the invention depicting various components of the system;

FIG. 2 is a screen capture depicting the graphical user interface of an embodiment of the invention;

FIG. 3 is a screen capture depicting the graphical user interface of an embodiment of the invention when a user highlights an individual room demarcation representing a room of a property that has been reserved;

FIG. 4 is a screen capture depicting the graphical user interface of an embodiment of the invention when a user highlights an individual room demarcation of a room of a property that is under maintenance;

FIG. 5 is a screen capture depicting the graphical user interface of an embodiment of the invention;

FIG. 6 is a screen capture depicting the graphical user interface of an embodiment of the invention depicting the plurality of room demarcations.

FIG. 7 is a screen capture depicting a folio of the graphical user interface of an embodiment of the invention;

FIG. 8 is a screen capture depicting a housekeeping list as displayed by the computer program of embodiments of the invention;

FIG. 9 is a screen capture depicting a menu to select a time period over which the ADR and the REVPAR are calculated;

FIG. 10 is a screen capture depicting various reporting details presented by the computer program of embodiments of the invention;

FIG. 11 is a flow chart depicting a set of steps performed by a method of embodiments of the invention.

FIG. 12 is a flow chart depicting a set of steps performed by a method of embodiments of the invention and specifically to calculate one or more statistics relevant to determine short-term and long-term goals of the property.

The drawing figures do not limit the current invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Embodiments of the invention provide a computer program, method, and property management system 10 for managing at least one property. The property includes at least one room available for rent by a lodger for temporary lodging. The computer program of embodiments of the invention executes certain steps that comprise the method of the invention. The system 10 for managing at least one property comprises a memory element 12 for storing the computer program, a processing element 14 for executing the computer program, and other components, as discussed below.

Reference will be made herein to a “property,” which is defined to include at least one building providing temporary lodging to a lodger. Exemplary properties include a hotel or a motel. As can be appreciated, a single property may in some instances encompass multiple buildings, such as different buildings of a large resort. Additionally, each building may include multiple rooms for lodging or may include only a single room. Each building may be a multi-story building each having multiple levels (or floors). Conversely, each building may have only a single floor. In yet other instances, the property may be a house, an apartment, a condominium, a plurality of cottages, etc. Additionally, a single property may have a heterogeneous mix of buildings with some having multiple floors while others have only a single floor. Some properties may have hundreds of rooms while others may have only a single room. Each room may include only one floor or multiple floors.

Reference herein to a “property” is also intended to identify a property that is managed or otherwise identified by its owner or manager as a single property. For example, large hotel chains frequently own or manage many hotels. The hotels may be spread out over large geographical distances, including different cities, different time zones, and even different countries and continents. Moreover, each property may have have users and lodgers speaking various languages and completing transactions related to the property in a variety of currencies. For large chains, the chain may own/manage properties in different countries and with different languages and currencies.

However, in some instances, there may be two hotels owned or managed by the same chain within close geographical proximity of each other, e.g., within the same city. If the hotel chain identifies or manages each of the two hotels as separate properties, then each hotel satisfies the defined “property” as used herein. However, if the hotel chain identifies or manages each of the two hotels as a single property, then the “property” as defined herein comprises both of the hotels. It is also contemplated that in some instances, the hotel owner/manager will identify a property having multiple buildings as a single property.

The system 10 of embodiments of the invention may comprise computing devices 15 to facilitate the functions and features described herein. The computing devices 15 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system. In various embodiments of the invention, the computing devices 15 may comprise a processing element 12, a memory element 14, a communication network 16, and/or a display 18.

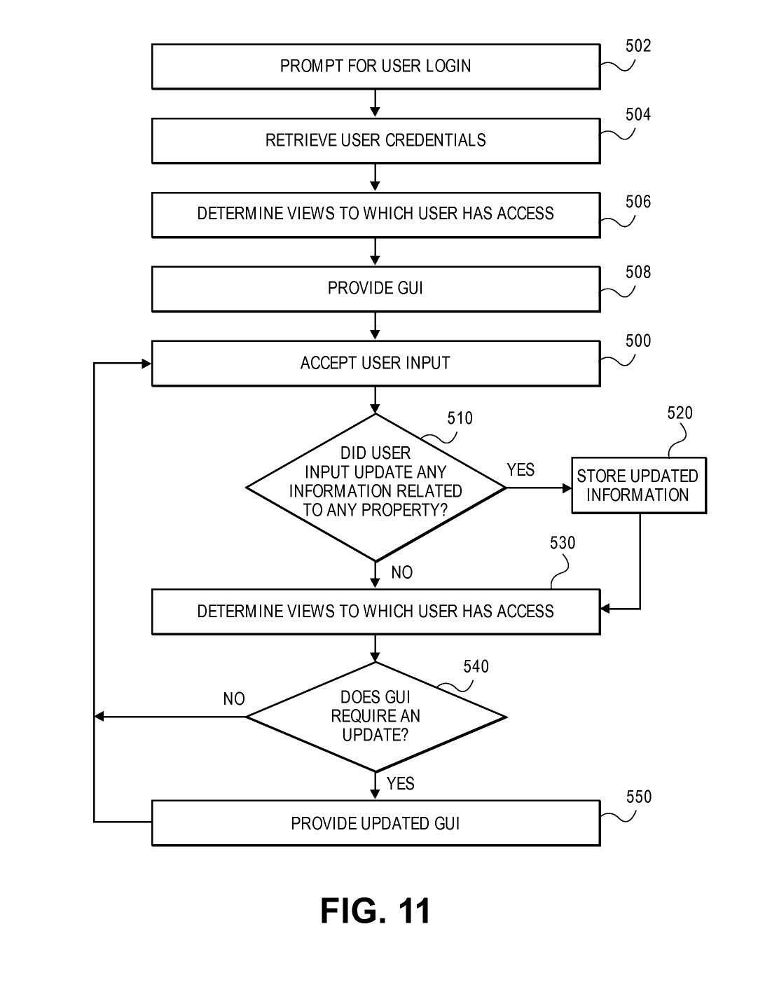

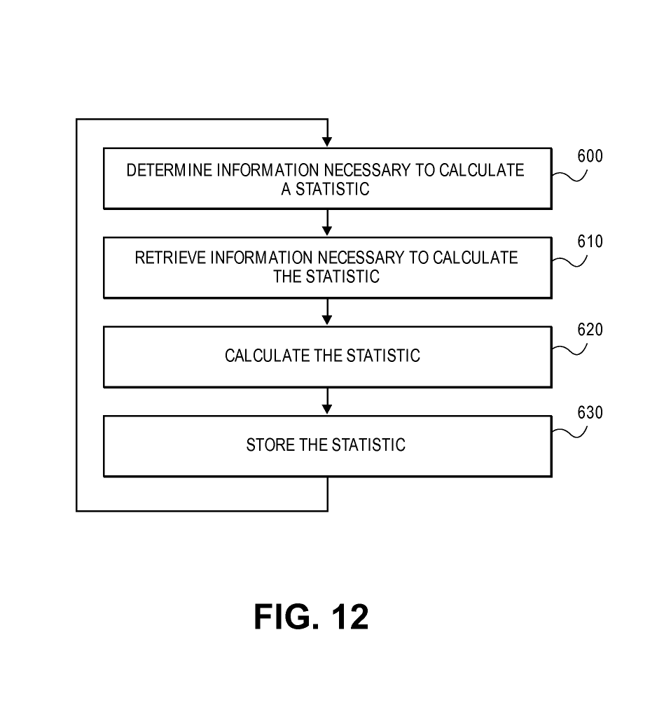

The computer program of embodiments of the present invention comprises a plurality of code segments executable by a computing device 15 for performing the steps of the method of the present invention. The steps of the method may be performed in the order shown in FIGS. 11 and 12, or they may be performed in a different order, unless otherwise expressly stated. Furthermore, some steps may be performed concurrently as opposed to sequentially. Also, some steps may be optional. The computer program may also execute additional steps not described herein.

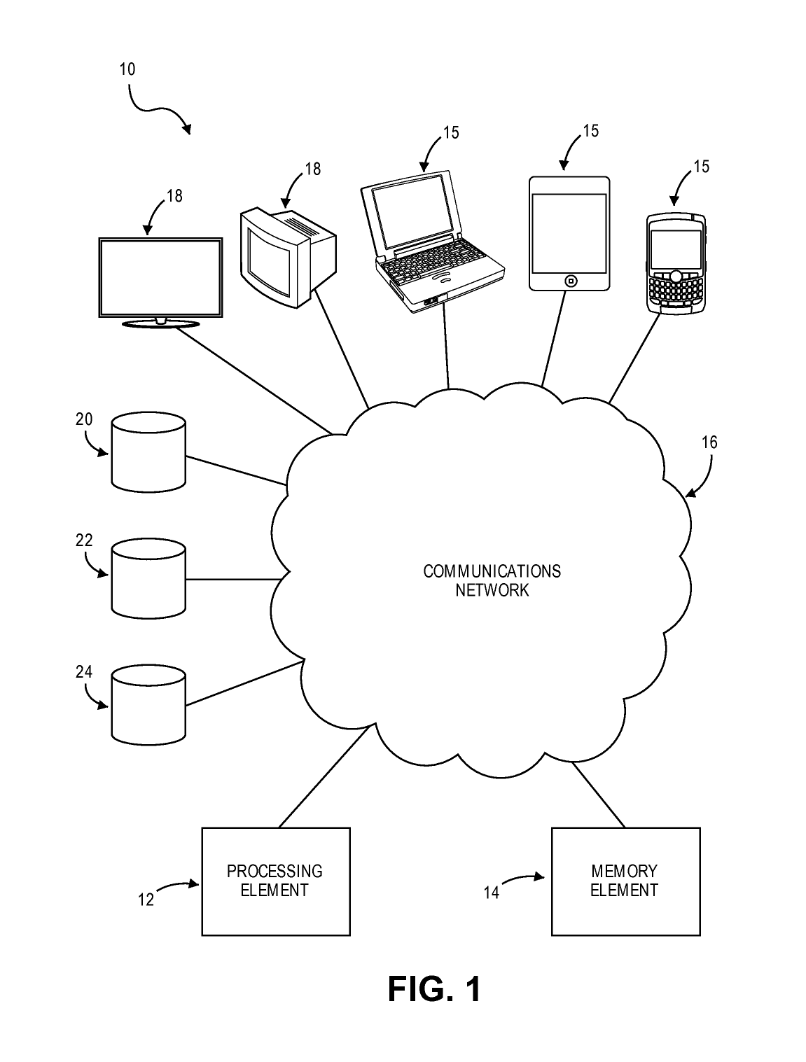

The computer program, method, and system of embodiments of the invention may be implemented in hardware, software, firmware, or combinations thereof using the system 10, shown in FIG. 1. The system 10 may include additional computing devices 15 that provide access to one or more general computing resources, such as Internet services, electronic mail services, data transfer services, and the like. The system 10 may also provide access to one or more databases, including a user database 20 that stores information particular to each user that accesses the resource described herein; a property information database 22 that includes information on the number of rooms of the property, room information for each room, amenities, and other property information; and a folio database 24 that includes personal lodger information (name, credit card information, address, etc.) and the type of rooms and amenities a lodger prefers. The databases may also store other information and data necessary for the implementation of the computer program, method, and embodiments of the invention.

The system 10 may include any device, component, or equipment with a processing element 12 and associated memory elements 14. The processing element 12 may implement operating systems and may be capable of executing the computer program, which is also generally known as instructions, commands, software code, executables, applications, apps, and the like. The processing element 12 may include processors, microprocessors, microcontrollers, field programmable gate arrays, and the like, or combinations thereof. The memory elements 14 may be capable of storing or retaining the computer program and may also store data, typically binary data, including text, databases, graphics, audio, video, combinations thereof, and the like. The memory elements 14 may also be known as a “computer-readable medium” or “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements 14, the devices may further include file stores comprising a plurality of hard disk drives, network attached storage, or a separate storage network.

Various computing devices 15 of the system 10 may specifically include mobile communication devices (including wireless devices), work stations, desktop computers, laptop computers, palmtop computers, tablet computers, portable digital assistants (PDA), smart phones, scanners, cash registers, cash drawers, printers, and the like, or combinations thereof. Various embodiments of computing devices 15 may also include voice communication devices, such as cell phones or landline phones. In embodiments, the devices will have an electronic display 18, such as a cathode ray tube, liquid crystal display, plasma, or touch screen that is operable to display visual graphics, images, text, etc. In additional embodiments, the computing devices 15 may include an optical device such as a digital camera, video camera, optical scanner, magnetic reading head, or the like, such that the computing device can capture, store, and transmit digital images and magnetic stripe cards.

User may communicate with the system 10 through one or more functionable inputs such as buttons, keyboard, switches, scrolls wheels, voice recognition elements such as a microphone, and pointing devices such as mice, touchpads, touchscreens, tracking balls, and styluses. User communication with the system 10 may also include a speaker for providing audible instructions and feedback. Further, communication with the system 10 may comprise wired or wireless data transfer elements, such as through the communications network 16, removable memory, data transceivers, and/or transmitters, to enable the user and/or other devices to remotely interface with the devices of the system.

The communications network 16 may be wired or wireless and may include servers, routers, switches, wireless receivers and transmitters, and the like, as well as electrically conductive cables or optical cables. The communications network 16 may further include buses, backplanes and various internal communication links contained with a single instance of a computing device 15. The communications network 16 may also include local, metro, or wide area networks, as well as the Internet, or other cloud networks. Furthermore, the communications network 16 may include cellular or mobile phone networks, as well as landline phone networks, public switched telephone networks, fiber optic networks, or the like.

The computing devices 15 may be connected to the communications network 16. In embodiments of the invention, multiple instances of computing devices 15 may be configured to run in a client/server configuration. In this instance, the computing devices 15 may be able to communicate with each other through the communications network 16. The connection to the communications network 16 may be wired or wireless. Thus, the computing devices 15 may include the appropriate components to establish a wired or a wireless connection.

When in a client server configuration, the computer program of the present invention may run on a single computing device 15 or, alternatively, may run on one or more computing devices. Thus, a first portion of the program, code, or instructions may execute on one computing device 15, while a second portion of the program, code, or instructions may execute on another computing device. In some embodiments, other portions of the program, code, or instructions may execute on additional computing devices 15 as well. For example, information particular to each user may be stored on a memory element 14 associated with the a first computing device 15, such that the information particular to each user is remotely accessible to a user, an administrator, or a brand owner using the computer program via one or more additional computing devices. In additional embodiments of the invention, a portion of the information to implement the present invention may be stored on a first computing device 15, while another portion may be stored on the one or more additional computing devices. The various actions, analyses, and calculations described herein as being performed by or using the computer program may actually be performed by one or more computers, processors, or other computational devices, such as the client devices and/or server devices of a client/server configuration, independently or cooperatively executing portions of the computer program.

In certain embodiments of the invention, the computer program may be embodied in a stand-alone program downloaded on a user's computing device 15 or in a web-accessible program that is accessible by the user's computing device via the network. For the stand-alone program, a downloadable version of the computer program may be stored, at least in part, on a server. A user can download at least a portion of the computer program onto the computing device 15 via the network. In such embodiments of the present invention, the computer program may be an “application,” such as an “app” for a mobile device. After the computer program has been downloaded, the program can be installed on the computing device in an executable format. The executable form of the program permits the user to access embodiments of the present invention via an electronic resource, such as a mobile “app” or website. For the web-accessible computer program, the user may simply access the computer program via the network (e.g., the Internet) with the computing device 15.

Once a user has access to the system 10, certain embodiments may provide for various types of users to create accounts with which to access the system. The user accounts may be stored within the databases of the computing devices 15. Certain embodiments of the present invention may provide for at least three types of user accounts, including a user account for a user making reservations or check-in and check-out lodgers of a property services, an administrator account for an administrator of the electronic resource, and a maintenance staff account for a company that provides products or services including repairs to a property. Each user account may provide users with unique roles, capabilities, and permissions with respect to implementing embodiments of the invention. However, such embodiments are provided for exemplary purposes only, and other embodiments of the invention may include any number and/or any specific types of accounts as may be necessary to carry out the functions, features, and/or implementations of the invention. For instance, certain other embodiments may provide for a role-based security feature, such that administrative users (i.e., the administrator), through their administrative accounts, may establish, maintain, and oversee a plurality of different types of accounts. Thus, the administrative users may establish and manage the roles, capabilities, and permissions of each of the different types of accounts.

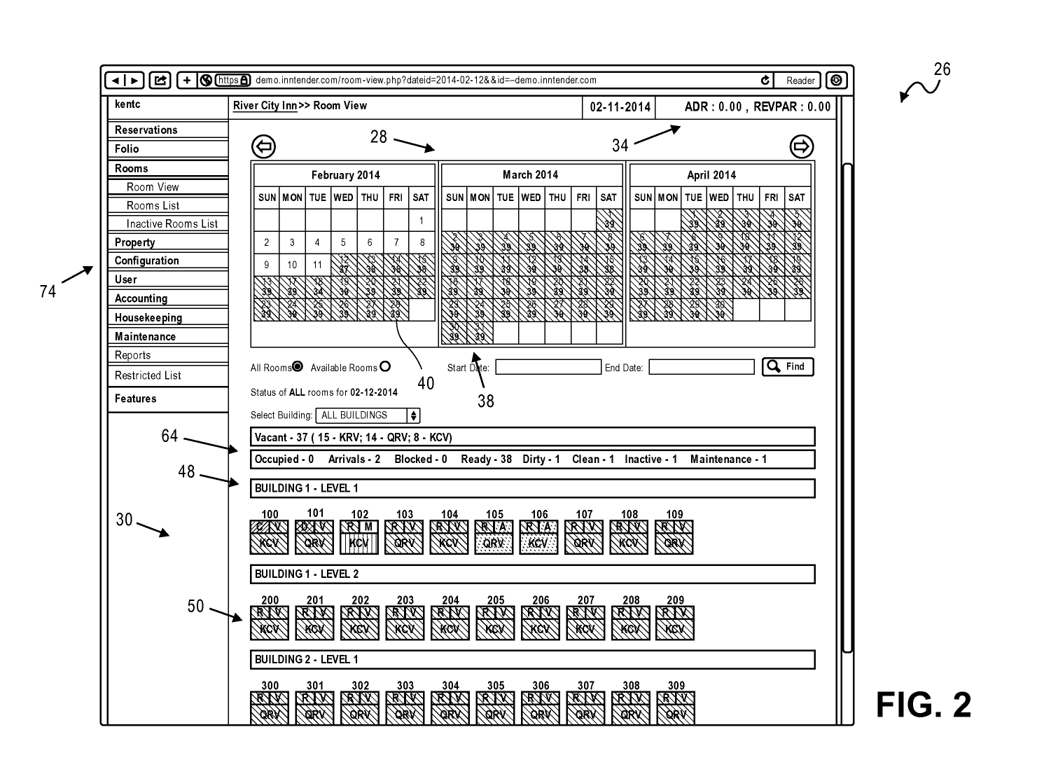

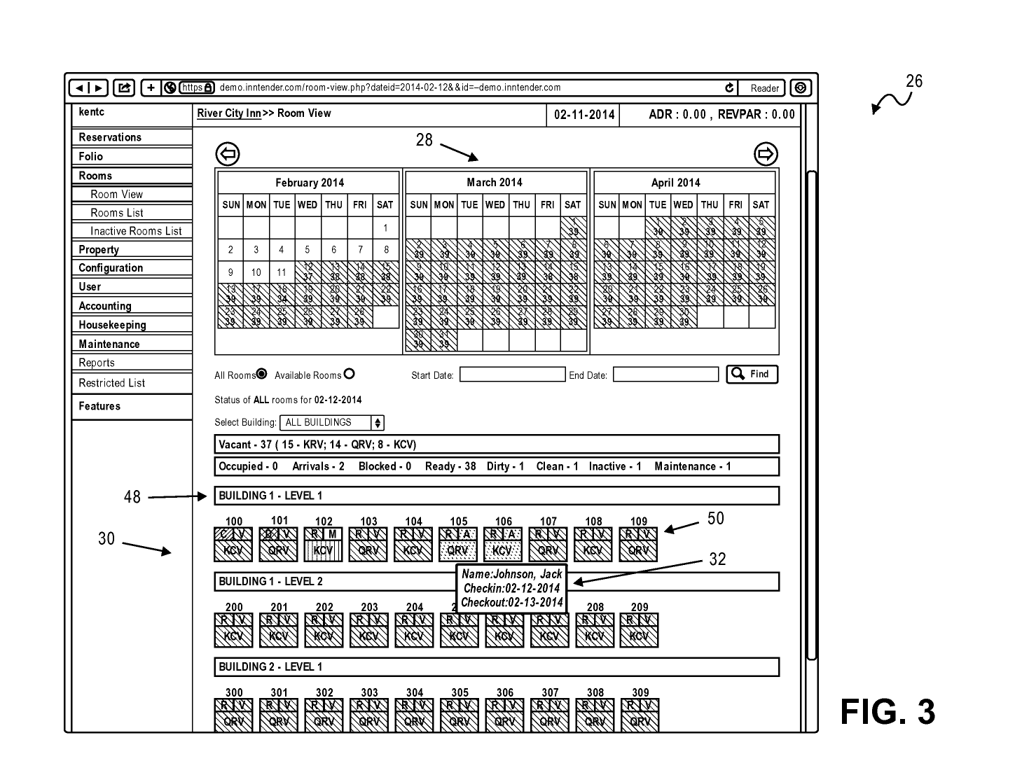

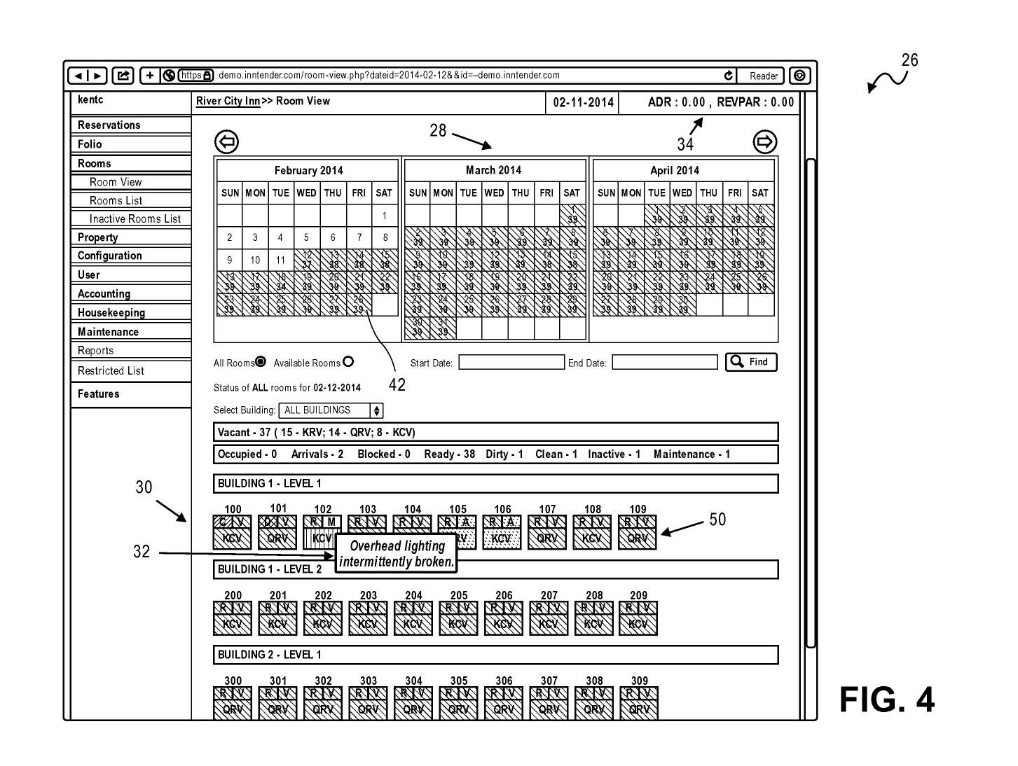

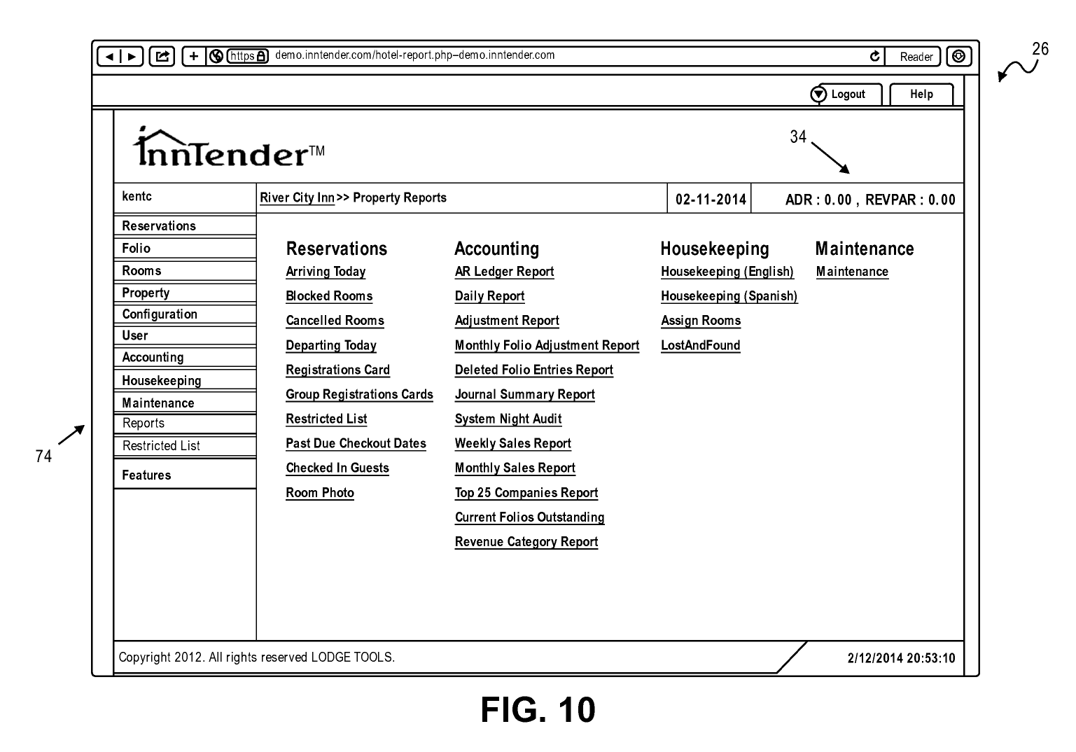

As noted above, the computer program of embodiments of the invention presents to a user a graphical user interface (GUI) 26 that displays a plurality of items of property management information in an intuitive and easy-to-use manner is show in FIGS. 2-10. The plurality of items of property management information is provided via the GUI 26 in a format that allows the user to visually associate particular items of information quickly and without opening multiple GUIs, performing lengthy and time-consuming searches, or filtering information via drop-down boxes or tabs or other search methods. As shown in FIGS. 2-5, the GUI 26 contemporaneously displays multiple interface elements including a calendar 28 for a selected time period, and a plurality of room demarcations 30 representing the rooms of a property. In embodiments, additional on-demand room details 32 are viewable in response to a user highlighting a room demarcation. In further embodiments of the invention, the GUI 26 additionally displays at least one statistic 34 to help users of the system achieve goals related to the property. The GUI 26 updates in real-time based on user input, as will be described later.

Exemplary, although not exhaustive, items of property management information include the following: room reservation information (e.g., which rooms are reserved, name and information for lodger reserving the room, how many rooms are reserved for the property, etc.), accounting matters including bills, nightly audits, customer delivery fees, pet boarding, smoking fees, and room and amenity charges; identification of corporation customers, individual lodgers, folios or profiles of lodgers, and transactional records printable onto paper for lodgers; and policies and violations including, smoking rules, room cancellation fees, property damage policies, corporate discounts, group rates, and satisfaction related fees. Additional items of property management information will be further discussed herein.

The computer program of embodiments presents to the user certain information dependent on the type of user (e.g., housekeepers, maintenance staff, property managers, concierges, inspectors, etc.). An administrator or manager may give permission to other users, create credentials, and create login accounts. Types of user accounts will be discussed in more detail below.

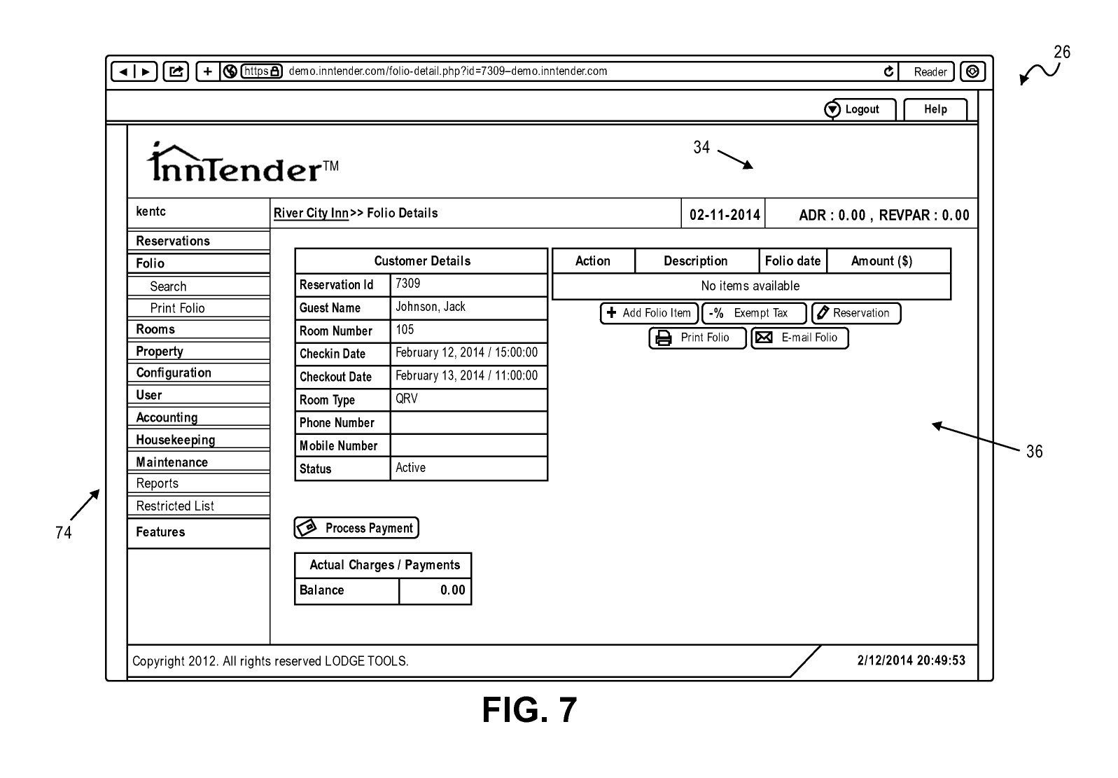

As shown in FIG. 7, a lodger folio 36 displayed by the GUI 26 stores information related to customers that are lodgers. The folio 36 provides an easy way for a user of the system to know all pertinent information about a particular lodger. Each lodger has their own folio 36 containing personal information, such as credit card information and phone number. The folio 36 also contains information related to a particular lodger's current room, including a reservation identifier, a room number or name, and a type of room. The folio 36 also lists information related to the lodger's current stay, including the check-in and check-out dates and the current charges associated with the room and any amenities of the property.

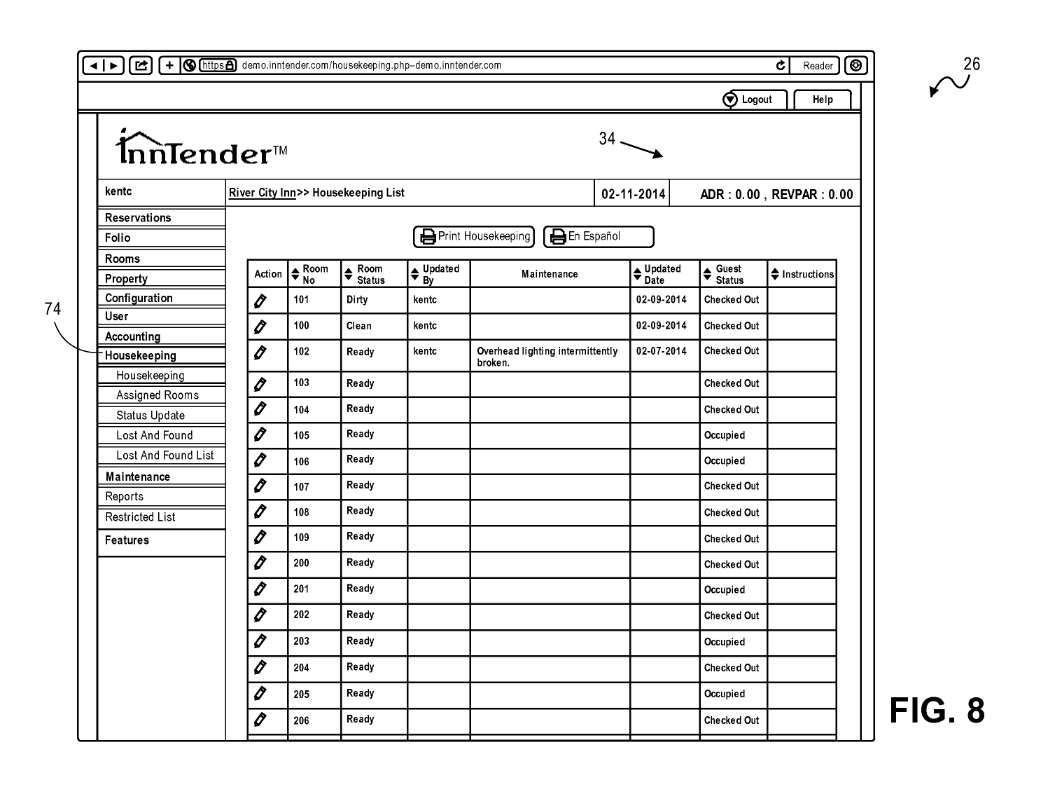

The computer program allows for the user to easily change certain items of property management. For example, amenities can be added to or subtracted from an amenities list as features are added to the property. Each room has a room amenities list with a subset of the amenities list representing the amenities. Each room amenities list is alterable by users as rooms are updated with different amenities. As a second example, a user list can be updated with sets of permissions as users changes roles and have different responsibilities related to the property. If a first user transitions from a housekeeper to a housekeeper supervisor, a second user can alter the role of the first user and thus grant the first user a housekeeper supervisor role. An exemplary housekeeping view is shown in FIG. 8. The updated permissions associated with the new role then allow the first user to access a different set of property management information.

As shown in FIGS. 2-5, the GUI 26 presented by the computer program contemporaneously displays the calendar 28 having a calendar demarcation 38 referring to a selected portion of time periods, and a numerical indication 40. The time periods may be days, weeks, or months. The selected portion is customizable such that the calendar 28 can display a specific time frame (e.g., the current and next two months, certain days of the week, a defined range requested by a lodger, etc.). The calendar 28 updates in real-time in response to user input.

The calendar demarcation 38 of the calendar 28 is a defined area representing the selected time period of the calendar. Within the defined area, the calendar demarcation 38 may include an outlined area and a set of numbers representing the time periods. In embodiments of the invention, the calendar demarcation 38 may only be the set of numbers representing the time periods without the area being outlined. In embodiments, each time period is outlined, and each day within the time period is further outlined. Portions of the calendar demarcation 38 may present a particular color based on a total occupancy status of the property, as described below.

The numerical indication 40 of the calendar 28 is a number representing the total occupancy status of the property. There is a numerical indication 40 for each time period represented by the calendar demarcation 38. For example, if each time period is a day, and the calendar demarcation 38 shows 30 or 31 time periods corresponding to a month, then the numerical indication 40 is the occupancy status for each day. The numerical indication 40 is proximate to the calendar demarcation 38. In embodiments where the calendar demarcation 38 is an outline of a time period, the numerical indication 40 may be inside the calendar demarcation. The occupancy status may either be the number of occupied rooms on the property for the time period or the number of unoccupied (or vacant) rooms for the time period. In yet other embodiments, the numerical indication 40 is the percentage of occupied or unoccupied rooms.

In embodiments of the invention, the numerical indication 40 and/or a portion of the calendar demarcation 38 is a first color 42 when the numerical indication satisfies a first condition, and a second color 44 when the numerical indication satisfies a second condition. For example, if the numerical indication 40 is indicating the occupancy status (which is a type of room information), and, specifically, a number of occupied rooms, then the numerical indication and/or the portion of the calendar demarcation 38 may be colored green if there are available rooms for the time period. The first condition is then that there are non-occupied rooms for the time period (i.e., that there are rooms available to be rented). In contrast, if the numerical indication 40 and/or the portion of the calendar demarcation 38 are colored red, then this is an indication that all rooms are occupied for the time period (i.e., that there are no available rooms to be rented). In embodiments of the invention, the calendar demarcation 38 and an area around the numerical indication 40 is a third color 46 when the numerical indication is a third value. The third color 46 may be yellow and the third value is a number representing a percentage of vacant rooms. The percentage of the third value may be customized by the system. Thus at a glance a user can determine based on the calendar demarcation 38 and numerical indication 40 the total occupancy status of the property.

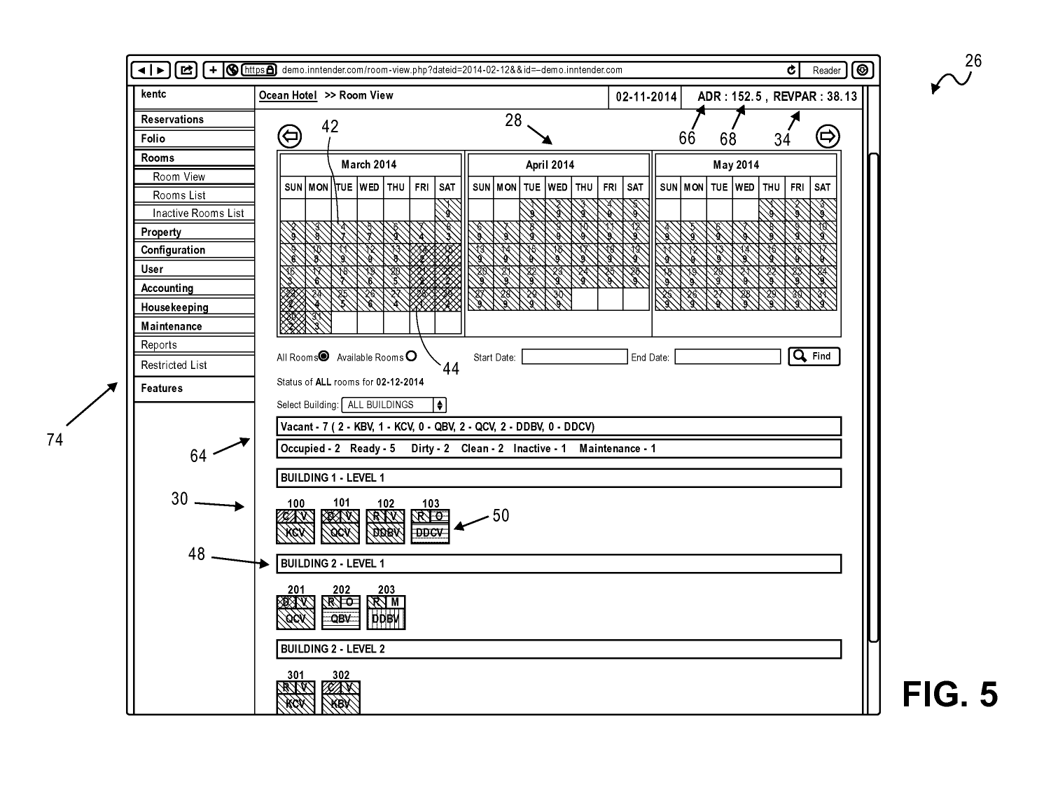

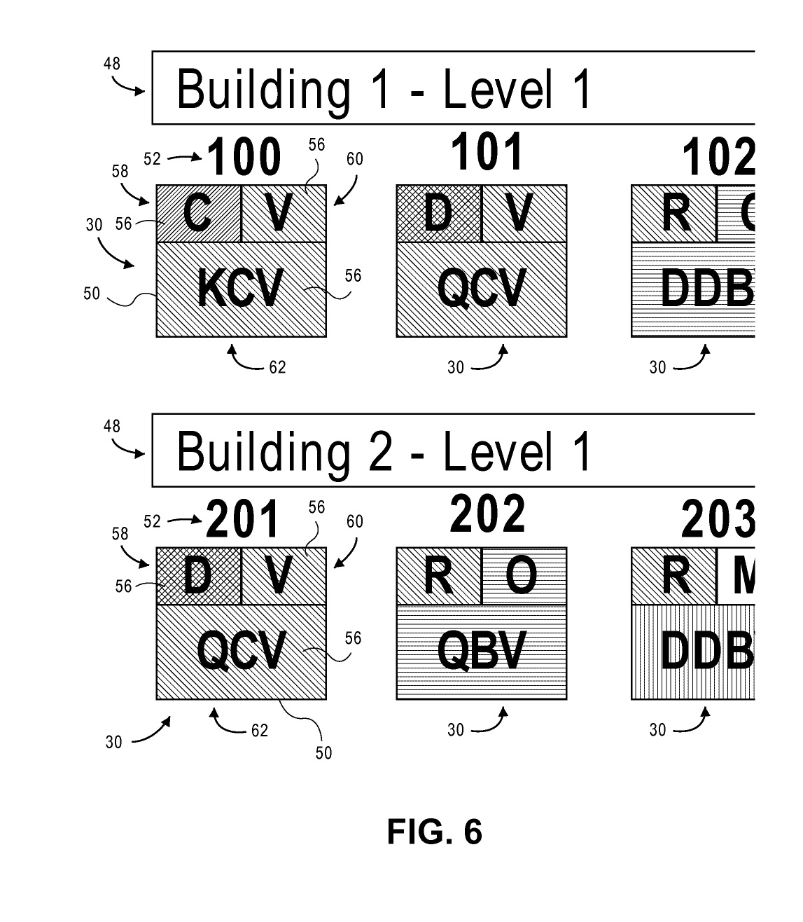

Referring to FIGS. 5 and 6, the computer program also provides a GUI 26 that contemporaneously displays the room demarcations 30. The room demarcations 30 are positioned below the calendar 28 on the GUI 26, although they may be positioned elsewhere relative to the calendar. Each room demarcation 30 corresponds to one of the rooms of the property, such that there is a room demarcation for each room of the property. In embodiments of the invention, the room demarcation 30 additionally includes identifiers 48 of the floor and building where each room of the property is located. In embodiments, the GUI 26 displays room demarcations 30 for the rooms of the property that are unoccupied. In other embodiments, the GUI 26 displays room demarcations 30 only for the rooms of the property on a particular floor or of a particular building. In embodiments of the invention, the system sorts and provides a display of the room demarcations 30 based upon user-defined criteria. The display of the GUI 26 of the room demarcations 30, like the calendar 28, is updated in real-time as the system is used. The room demarcations 30 are responsive to user input, as will be described later.

Each room demarcation 30 is an outline 50 with a defined area therein representing the room and a number 52 corresponding to the room number or name of the room. Though the area is outlined for exemplary purposes, it should be appreciated that certain embodiments of the invention may simply provide a pre-set and defined area on the GUI 26 that is not necessarily outlined, and this pre-set and defined area would be the room demarcation 30. In embodiments, the defined area of each room demarcation 30 is subdivided into a number of subareas. In embodiments of the invention, the defined area is subdivided into at least two subareas. The subareas each provide a place to give information about a given room. Proximate to the room demarcation 30 is a plurality of items of room information 54 and, if applicable, subareas.

The computer program also provides a GUI 26 that contemporaneously displays the plurality of items of room information 54. There is a plurality of items of room information 54 for each displayed room. As will be discussed later, each item of room information 54 quickly conveys a piece of information about a room. Some items of room information 54 convey multiple pieces of information about a room. The items of room information 54 relate to various disparate types of information that describes a particular room: whether the room is occupied; whether the room is dirty or clean; whether the room has a certain type of amenity or feature; the type of view, if any, from any window of the room; a policy or rule associated with the room; whether the room is inactive or under maintenance; or whether the room has a reservation, is blocked from making any new reservations, or is available for reservations.

The physical proximity of each item of room information 54 to the respective room demarcation 30 as displayed by the GUI 26 allows a user to visually associate each item of room information with the respective room. In embodiments with subareas, each item of room information 54 is proximate to the subarea of the room demarcation 30. For each item of room information 54, there is at least the first condition. In embodiments of the invention, each item of room information has more than one condition.

A coded identifier 56 represents each item of room information 54. The coded identifier 56 enhances the ability of a user of the system 10 to look at the GUI 26 and quickly identify information about a room. The coded identifier 56 allows a user to visually know whether each item of room information 54 satisfied a first condition or a second condition. In embodiments where there are more than two conditions for a given item of room information 54, the coded identifier 56 allows a user to visually know any of the multitudes of conditions.

The coded identifier 56 may be letters, numbers, pictures, symbols, or any other visual representation. In embodiments of the invention, the coded identifier 56 may also be a combination of visual representations, such as letters and symbols displayed together. Additionally the coded identifier 56 is also one or more stylistic variations to the visual representation. Stylistic variations of the coded identifier 56 include but are not limited to the following: the color of letters or numbers; the color of the subarea of the room demarcation 30 surrounding the visual representation; the color of multiple subareas of the room demarcation 30; a texture or pattern of the subarea of the room demarcation 30 surrounding the visual representation; the font of the visual representation; the size of the visual representation; and the orientation of the visual representation.

Having described the layout and function of the room demarcations 30 and the plurality of items of room information 54, an embodiment of the invention regarding certain items of room information and their respective coded identifiers 56 will now be described. The following description is for illustrative purposes and it should be understood that some properties will convey other items of room information 54. Thus, in embodiments of the invention, the system 10 could be configured to provide a GUI 26 that displays different room demarcations 30 with a different plurality of items of room information 54 and different coded identifiers 56.

As shown in FIG. 6, the defined area of each room demarcation 30 is subdivided into three subareas: the first subarea is square shaped and in the upper left portion of the room demarcation; the second subarea is square shaped and in the upper right portion of the room demarcation; and the third subarea is a rectangle below the first and the second subareas. The defined area of each room demarcation 30 has an outline 50 as well as additional lines to help indicate the subareas. Each subarea of the room demarcation 30 is updated in real-time. Inside the first subarea is a first item of room information 58. Inside the second subarea is a second item of room information 60. Inside the third subarea is a third item of room information 62.

The first item of room information 58 is a room status, although it should be appreciated that the first item of room information may be some other item of room information. The room status has a first condition when a room of the property is clean and a second condition when the room is dirty. The coded identifier 56 of the first item of room information 58 is two letters: the first letter is C, and the second letter is D. The coded identifier 56 of the first item of room information 58 is also two colors: the first color is tan and the second color is yellow. The colors refer to the first subarea itself and not to the letter. The room demarcation 30 displays the letter C for the first item of room information 58 and displays the color of the first subarea as tan when the room status is the first condition. The room demarcation 30 displays the letter D for the first item of room information 58 and displays the color of the first subarea as yellow when the room status is the second condition. In embodiments of the invention, the room status has a third condition when the room is ready. In this embodiment the coded identifier 56 is the additional letter R and the first subarea is the additional color green. Thus, the room demarcation 30 displays the letter R and the color of the first subarea as green for the first item of room information 58 when the room status is the third condition.

The second item of room information 60 is an occupancy status. The occupancy status has a first condition when a room of the property is vacant and a second condition when the room is occupied. The coded identifier 56 of the second item of room information 60 is two letters: the first letter is V, and the second letter is O. The coded identifier 56 of the second item of room information 60 is also two colors: the first color is green and the second color is blue. The colors refer to the second subarea itself and not to the letter. As will be described below, the coded identifier 56 of the second item of room information 60 is also the color of the third subarea. The room demarcation 30 displays the letter V for the second item of room information and displays the color of the second subarea as green when the occupancy status is the first condition. The room demarcation 30 displays the letter O for the second item of room information 60 and displays the color of the second subarea as blue when the occupancy status is the second condition. In embodiments of the invention, the occupancy status has a third condition when the room needs maintenance. When a room needs maintenance, the room could be undergoing improvements such as upgrading the room with a new bed or redoing the drywall in the room; it could also be that the room is missing something, such as a television remote for a television in the room. In this embodiment the coded identifier 56 is the additional letter M, and the second subarea is the additional color white. Thus, the room demarcation 30 displays the letter M and the color of the second subarea as white for the second item of room information 60 when the room is the third condition.

The third item of room information 62 is a room type. The room type conveys multiple pieces of information about a room of the property. The first piece of information is the bed in the room. This first piece of information satisfies a first condition when the room has a single king-sized bed. The first piece of information satisfies a second condition when the room has a single queen-sized bed. The first piece of information satisfies a third condition when the room has two double-sized beds. The coded identifier 56 of the first piece of information may also be the letter K if the first condition of a single king-sized bed is satisfied; the letter Q if the second condition of a single queen-sized bed is satisfied; and the letters DD if the third condition of a two double-sized beds is satisfied.

The second piece of information of the third item of room information 62 is the view in the room. The second piece of information satisfies a first condition when the room has a beach view. The second piece of information satisfies a second condition when the room has a city view. The coded identifier 56 of the second piece of information may also be the letters BV is the fist condition of a beach view is satisfied; and the letters CV if the second condition of a city view is satisfied.

The room demarcation 30 displays the first and second pieces of the third item of room information 62 next to each other in the third subarea in the following permutations: KBV, QBV, DDBV, KCV, QCV, and DDCV. Thus if a room has a king-sized bed and has a city view, the coded identifier 56 of the third item of room information 62 is the letters KCV. If a room has two double-sized beds and a beach view, the coded identifier 56 of the third item of room information 54 is the letters DDBV, respectively.

The coded identifier 56 of the third item of room information 62 is also a color of the third subarea. The coded identifier 56 does not directly describe the room type but, as described above, the occupancy status of the room. When the room demarcation 30 displays the color of the second subarea as green when the occupancy status is the first condition, the room demarcation also displays the color of the third subarea as green. When the room demarcation 30 displays the color of the second subarea as blue when the occupancy status is the second condition, the room demarcation also displays the color of the third subarea as blue. The room demarcation 30 displays the color of the second subarea as white when the occupancy status is the third condition, but not the third subarea. The system 10 has set the room demarcation 30 to display the color of the third subarea as red when the occupancy status is the third condition. Because a room under maintenance cannot be rented until fixed, the contrasting red and white adjacent subareas draw attention to users of the system 10; the color red also informs a user of the system that the room is inactive.

In embodiments, the GUI 26 additionally displays a summary 64 of rooms of the property contemporaneously with the calendar 28 and the room demarcations 30. The GUI 26 simultaneously displays the summary 64 between the calendar 26 and the room demarcations 30. In embodiments, the GUI 26 simultaneously displays the summary 64 below the calendar 28 and below the room demarcations 30. The summary 64 displays a plurality of room categories and a plurality of room subtotals, each related to the plurality of items of room information 54 displayed by the room demarcations. The plurality of room categories uses a coded identifier similar to but not always identical to the coded identifiers 56 of the plurality of items of room information 54. The coded identifier of some of the categories is a single word. The coded identifier of some of the categories is multiple letters. The coded identifier of each category is also a color. The plurality of room subtotals also uses a coded identifier similar to but not always identical to the coded identifiers 56 of the plurality of items of room information 54. The summary 64 updates in real-time as users update the system 10. The similarity of the coded identifiers 56 in the plurality of items of room information 54 of each room demarcation 30 and the room categories and the room subtotals helps a user understand that although the information is organized differently, it conveys related or similar information.

To further illustrate and explain the summary 64 of the GUI 26, the example of the room demarcation 30 above will be referenced, and again attention is drawn to FIGS. 5 and 6. The first room category and room subtotal convey the number of vacant rooms. The coded identifier of the first room category is the word “Vacant” and the color of the word is green. This is the same color as the coded identifier 56 of the second item of room information 60, namely vacancy status. Also, the coded identifier for the first room subtotal is the same color green. Next to the first room category and room subtotal are six room categories for each room type and six room subtotals displaying the number of vacant rooms for each room type. The coded identifier for these six room categories is multiple letters. The coded identifier is the same as that displayed for the third item of room information 62: KBV, QBV, DDBV, KCV, QCV, DDCV. The coded identifier for these six room categories is also that the multiple letters are the color white. The coded identifier for the six room subtotals is also the color white. There are additional room categories and room subtotals corresponding to the first item of room information 58 and the second item of room information 60.

An eighth room category and room subtotal has a coded identifier of the word “Occupied” and the word is the color blue. This allows a user to glance and see the totality of occupied rooms of the property because the word and color correspond to the coded identifier 56 of the letter O and the color blue for the second item of information 60 in a particular room demarcation 30. A ninth room category and room subtotal has the coded identifier 56 of the word “Ready” and the word is the color green. This allows a user to glance and see the totality of all ready rooms of the property because the word and color correspond to the coded identifier 56 of the letter R and the color green for the first item of information 58 in a particular room demarcation 30. A tenth room category and room subtotal has the coded identifier of the word “Dirty” and the word is the color yellow. This allows a user to glance and see the totality of dirty rooms of the property because the word and color correspond to the coded identifier 56 of the letter D and the color yellow for the first item of information 58 in a particular room demarcation. An eleventh room category and room subtotal has the coded identifier of the word “Clean” and the word is the color tan. This allows a user to glance and see the totality of clean rooms of the property because the word and color correspond to the coded identifier 56 of the letter C and the color tan for the first item of information 58 in a particular room demarcation 30. A twelfth room category and room subtotal has the word “Inactive” and the word is the color red. This allows a user to glance and see the totality of inactive rooms of the property because the word and color correspond to the coded identifier 56 of the color red of the third item of information 62 in a particular room demarcation 30. A thirteenth room category and room subtotal has the word “Maintenance” and the color white. This allows a user to glance and see the totality the of rooms of the property needing maintenance because the word and color correspond to the coded identifier 56 of the letter M and the color white of the second item of room information 60 in a particular room demarcation.

As mentioned earlier, the system 10 provides additional on-demand room details 32 in response to a user highlighting a room demarcation 30; attention is drawn to FIGS. 2-4. These room details 32 provide information relevant to the room represented by the room demarcation 30. The room details 32 are information related to the occupancy, such as the first and last name of a lodger who is or will soon be occupying a room. In embodiments of the invention, the room details 32 are the first initial and the last name of a lodger as well as the lodger's check-in time and check-out time. In embodiments, the room details 32 are information related to the condition of a room, such as something broken in the room. In embodiments, the room details 32 regard a plurality of rooms; such as the name, location, and a primary lodger related to an event for which multiple rooms are booked or reserved. The room details 32 are displayed over a portion of the room demarcations 30. This portion is located and sized such that multiple room demarcations 30 are partially obscured by the room details 32. The room details 32 do not, however, completely obscure any individual room demarcation 30 so as not to disorient a user of the system 10.

The above room details 32 may be provided in response to a user input relative to the room demarcation 30. For example, if the user guides a mouse or trackpad of a computing element to the room demarcation 30, the computer program is operable to display a balloon or information field proximate the room demarcation with the additional information. When the user removes the mouse or trackpad from the room demarcation 30, the balloon or information field disappears. Additional user inputs relative to the GUI 26 are described below.

In embodiments of the invention, the GUI 26 provided by the system 10 simultaneously displays at least one statistic 34 helpful to users of the system. The statistic 34 is a subset of information related to the property. The statistic 34 is updated as users add and alter information stored by the computer program. The statistics 34 are helpful because they inform a user about the property and can be used to achieve goals related to the property (e.g., selling more rooms, making more money from each room, eliminating drops in average occupancies for a property, raising the average number of rooms filled for a property in a certain jurisdiction, etc.). In embodiments of the invention, the GUI 26 simultaneously displays a first statistic and a second statistic, and the statistics 34 are updated in real-time. In embodiments of the invention, the statistic 34 is calculated for all properties at the present time. In other embodiments, the statistic 34 is calculated for a period of time such as days, weeks, months, or years. In yet further embodiments, the statistic 34 is a first statistic calculated for a given time period, such as the first week of every month as far back as data exists in the system to calculate said first statistic; and a second statistic calculated for a related time period, such as the first week of the most recent three months.

The statistic 34 refers to all the rooms of the property, or the statistic 34 may refer to a subset of the rooms of the property. In embodiments of the invention where the property is a building with multiple floors, the statistic 34 may refer to all the rooms on every floor of the property or the statistic may refer to a subset of rooms located on a single floor of the property. In embodiments where the property is made of multiple buildings, the statistic 34 may refer to all rooms of all buildings, or only the rooms of a subset of buildings of the property. In embodiments of the invention where the system 10 is used to manage multiple properties, the statistic 34 includes a reference to any of the following: all the rooms of a single building of a single property having multiple buildings; a subset of rooms of a single building of a single property; all the rooms of all the buildings of a single property having multiple buildings; all the rooms of a first property and all the rooms of a second property; and all the rooms of only a first property but not a second property.

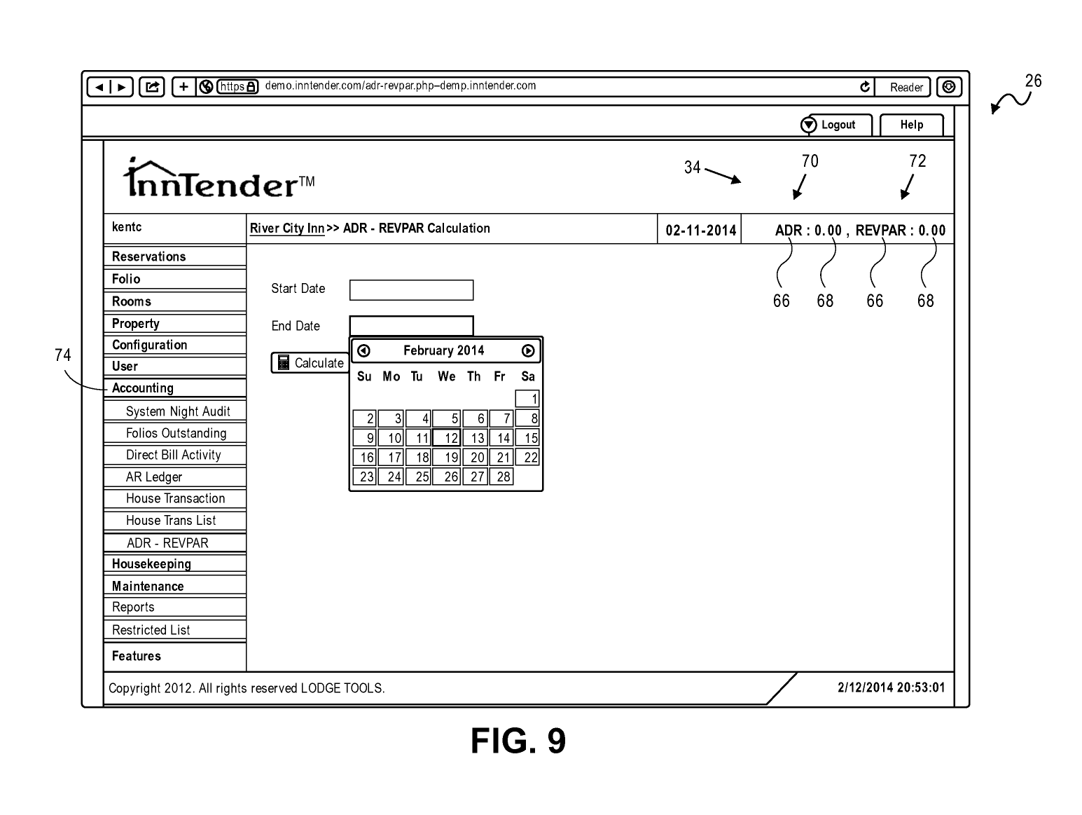

The statistic 34 is displayed on the GUI 26 above the calendar 28, such that it is prominently placed so a user at a glance can locate the statistic, although the statistic may be presented elsewhere on the GUI. As shown in FIGS. 2-10, even when a user navigates to other views, the GUI continues to display the statistic 34. The location is also logical because, as mentioned above, the statistic 34 may describe information related to multiple properties managed by a user. As shown in FIG. 9, each statistic 34 has a label 66 and a value 68. The label 66 is an abbreviation known by a user of the system 10 to reference a certain type of information related to the property. It can be appreciated that the label 66 can also be a symbol, a picture, a glyph, or a word or words depending on what best conveys the type of information; an abbreviation for the label is for exemplary purposes only.

The value 68 of each statistic 34 is displayed on the GUI 26 to the right of the label 66. The value 68 is a decimal number representing the statistic 34 as it is currently. It should be appreciated that the statistic 34 can also be a fraction, a percentage, a whole number, a symbol, a picture, a glyph, a word or words, or a color or colors, depending on what best conveys the type of information, and that a decimal for the value 68 is for exemplary purpose only.

The GUI 26 provided by the system 10 simultaneously displays a first statistic 70 and a second statistic 72. The first statistic 70 displayed by the GUI 26 is the Average Daily Rate (ADR) of the property. The label 68 of the first statistic 70 is the abbreviation of Average Daily Rate, namely “ADR.” The value 68 of the first statistic 70 is the sum of the revenue of each room of the property divided by the number of currently occupied rooms of the property. The second statistic 72 displayed by the GUI 26 is the Revenue Per Available Room (REVPAR) of the property. The label 66 for the second statistic 72 is the abbreviation of Revenue Per Available Room, namely “REVPAR.” The value 68 of the second statistic 72 is the ADR multiplied by the occupancy rate.

Embodiments of the invention provide the ADR, REVPAR, and any other desired statistic 34 in real-time and for the property. In yet other embodiments, the ADR, REVPAR, and any desired statistic 34 are provided in real-time and for multiple properties. In particular and as discussed above, in some cases, a property owner/manager (or simply “manager”) may own/manage multiple properties. In some instances, the manager desires to obtain an ADR or REVPAR number for a single property, but in other instances, the manager wants statistics for a plurality of its properties. In such a case, the computer program of embodiments of the invention provides an option to the manager to view the statistics 34 in real time and for the plurality of properties. In yet further embodiments, the manager may set goals for the desired statistics 34 for one or the plurality of properties.

Using a single property as a first example, the computer program provides the manager an option to set a goal for the daily ADR and REVPAR. Because these values are updated in real time and are continuously updated in response to any received reservations or room information changes, the manager continuously knows throughout the day whether the goals are being met. The manager can then use this information to change rates for the single property. For example, if the ADR is high and the occupancy rate is low, the manager may make a decision to lower room rates to incentivize a higher occupancy rate. Alternatively, the computer program may offer the option to the user to select a break-even rate versus a certain percentage profit rate. For example, there may be a certain ADR and REVPAR that allows the property to “break even” in costs and revenue for a certain time period. The manager may select the “break even” ADR/REVPAR based on pre-set “break even” values. The computer program will then suggest to the manager ADR and REVPAR values that would accomplish the break even value. Alternatively, if the manager desires a 10% profit for the set time period, the computer program offers the manager the option to select such and then suggests the ADR/REVPAR values that would accomplish the 10% profit.

Using multiple properties as an example, in some instances, the properties managed by the property manager may be separated by many time zones. If the manager has a particular ADR/REVPAR goal for the day for all properties, then knowing the ADR/REVPAR for a property in a time zone where the common check-in period has expired (e.g., it is late in the day and it is unlikely any other lodgers will be reserving the property) allows the manager to change ADR/REVPAR goals for properties located in a later time zone. As such, if the ADR/REVPAR goals are already met for the property located in the earlier time zone, then the manager may select a higher ADR for the property located in the later time zone to maximize profit.

As has been described, the computer program provides the GUI 26 that simultaneously displays the calendar 28, the plurality of room demarcations 30, the summary 64 of rooms, in some situations room details 32 additional to the room demarcations, and at least one statistic 34. The system 10 also generates and provides an updated GUI 26 in response to a user input. The form of the user input changes depending on the type of device displaying the GUI 26 provided by the computer program. The user input may take the form of direct interaction by touching, swiping, drawing, pinching or any other touch-screen gestures in the case of a touch-screen interface. The user input may take the form of indirect interaction by pointing, clicking, hovering a cursor, dragging, dropping or any other pointer gesture in the case of a mouse or pointer interface. The user input may also take the form of a key press in the case of a keyboard interface. In most circumstances, including to check-in or check-out lodgers, to select a period for the display of the plurality of room demarcations 30, to make reservations, to update whether a room is clean or dirty, or to switch to a different view, a user interacts with the GUI 26 by way of a first user input. In the case of highlighting to make room details 32 available, a user interacts with the GUI 26 by way of a second user input.

In a first example, the first user input is a click from a mouse on a portion of the menu 74 representing maintenance because one room of the property has a broken sink in the room's bathroom. Responsive to the first user input in the first example, the system provides an updated GUI 26 regarding the room and areas to input maintenance-related information about the room. In a second example, the first user input is a click from a mouse on a room demarcation 30 representing an available room because a lodger wants to make a reservation for the available room. Responsive to the first user input in the second example, the system provides an updated GUI 26 with a new view regarding the room and areas to input the lodger's relevant information. In a third example, the first user input is a click from a mouse on a particular date of the calendar 28 because the room availability for that date is needed. Responsive to the first user input in the third example, the system provides an updated GUI 26 with the same calendar 28 and statistic, but with an updated plurality of room demarcations 30 reflecting said room demarcations having new items of room information 54 reflecting the various states of the rooms on that date.

In a fourth example, the second user input is hovering a mouse cursor over a room demarcation 30 having an item of room information 54 indicating an occupied room. Responsive to the second user input in the fourth example, the system provides an updated GUI 26 with the following: the name of the lodger occupying the room, the check-in date of the lodger, and the check-out date of the lodger. In a fifth example, the second user input is ceasing to hover a mouse cursor over a first room demarcation 30 because more information regarding an adjacently displayed second room demarcation is needed. Responsive to the second user input in the fifth example, the system 10 provides an updated GUI 26 with the plurality of items of room information 54 of the second room demarcation no longer partially obscured by the room details of the first room demarcation.

Turning now to FIGS. 11 and 12, execution of the computer program of embodiments of the invention performs steps of the method of embodiments of the invention. Because multiple users may be updating information stored, displayed, and acted upon by the computer program, information displayed by the computer program is displayed in real-time. “Real-time” as defined herein is when the processing element of the system 10 performs the steps less than every 1 second, every 500 milliseconds, every 100 milliseconds, or every 16 milliseconds.

The method of embodiments of the invention broadly comprises the following steps: accepting user input 500, determining if information related to any property has been updated by the user input 510, storing any updated information related to the property 520, determining the views to which a user has access 530, determining if the GUI requires an update 540, and providing an updated GUI 550. Initialization of the computer program by a user, as may occur when a hotel owner/manager is setting up a property in the computer program, includes four additional steps: prompting for the user to login to the system 502, retrieving the credentials input by the user 504, determining the views of the GUI to which the user has access 506, and providing the GUI 508. The provided GUI 26 and any updated GUI provided by the system 10 will necessarily have a menu 74 listing the views to which the user has access.

The steps of prompting for the user to login 502, providing the GUI 508, and providing an updated GUI 550, all take into consideration the location and nationality of users of the system. In response to these user characteristics, or as set by administrators of the system, the provided GUI 26 is displayed in a specific language (e.g., English, French, German, Japanese, etc.), thus making the GUI more intuitive and easier to use for users. Further, the steps of providing a GUI 508, storing updated information related to the property 520, and providing an updated GUI 550 reflect the currency utilized in the government jurisdiction where the property is located. In embodiments of the invention, all transactions related to any property are stored in a first currency, and the step of providing a GUI 508 and providing an updated GUI 550 convert the transaction to a second currency for each property defined by the program.

The step of determining if the GUI requires an update 510 verifies both updates from the present user and updates from other users of the system 10. A first user could have requested an updated GUI 26 through a user input that requests a new view or updates information related to a property. In the case of a first user and a second user both using the system, the second user in a second instance of the GUI 26 could have updated information related to a property that the first user is currently viewing in a first instance of the GUI. In this case the computer program providing the GUI 26 would then update both the first instance of the GUI and the second instance of the GUI.

The steps of achieving goals set by the hotel owner or manager broadly comprises the following steps: determining which information related to any property is necessary to calculate the statistic 600, retrieving information necessary to calculate the statistic 610, calculating the statistic requested by the user 620, and storing the updated statistic 630. As lodgers begin to occupy rooms of any property and use related amenities, information related to a property will change. Therefore the step of retrieving information necessary to calculate the statistic 610 will need to be performed every time the statistic 34 is calculated. Because the statistic 34 is a subset of information related to the property, the GUI 26 will be updated to reflect any updated statistic. Because the GUI 26 may be used for properties in various jurisdictions utilizing different currencies, the step of calculating the statistic requested by the user 620 may involve converting the transaction between a first currency and a second currency. In embodiments of the invention, all transactions related to any property are stored in a single currency. In this embodiment the step of calculating the statistic requested by the user does not involve converting the transaction between a first and a second currency.

Operation and use of the system 10 will now be described in greater detail. Because the system 10 may provide multiple instances of the GUI 26, an example will be described with multiple users using the system. A first user is a housekeeper and a second user is a manager. The system 10 prompts the housekeeper to log into the system. The housekeeper inputs their credentials and the computer program determines the GUI 26 views to which the housekeeper has access. The computer program then displays the GUI 26 with the calendar 28 and the room demarcations 30 for each of the rooms of the property. The housekeeper can quickly glance at the room demarcations 30 and determine the cleanliness of the rooms. The codified identifiers 56 of the plurality of items of room information 54 inform the housekeeper both by the letters and the colors. The housekeeper also looks at the calendar 28 simultaneously displayed by the GUI 26 and can see that tomorrow there are many lodgers scheduled because the numerical indication 40 of vacancies is a very small number.

At 3 pm on a Friday, the housekeeper clicks on the calendar 28 with a mouse on the calendar demarcation 38 representing tomorrow and the system 10 provides an updated display with the same calendar 28 but updated room demarcations 30. The updated room demarcations 30 display items of room information indicating 54 that a large set of rooms has been blocked on the second floor of the first building of the property. The housekeeper hovers the mouse cursor over one of the room demarcations 30 that are indicated as blocked. The system 10 provides an updated display with overlaid room details 32 that provide a description indicating that a wedding party is scheduled to check-in at 6 pm tomorrow.

As the housekeeper cleans the rooms, the housekeeper updates the system 10. The housekeeper cleans a dirty room on the first floor and then uses the GUI 26 to switch to the housekeeping view. There the housekeeper updates the room status to indicate that the room on the first floor is clean. As the housekeeper begins to clean the last room on the second floor, the housekeeper notices that there is no water pressure in the last room. The housekeeper finishes cleaning the last room of the second floor and again uses the system 10 to update the room status to indicate that the last room on the second floor is clean. The housekeeper uses the GUI 26 to switch to the maintenance view, and puts the last room of the second floor in an inactive status due to the room needing maintenance.

At 4 pm, the system 10 prompts the manager to log into the system. The manager inputs their credentials and the system 10 determines the views to which the manager has access. The system 10 then displays a second instance of the GUI 26 with the calendar 28 and the room demarcations 30 for each of the rooms of the property for the current day, as well as a menu 74 with the views to which the manager has access. The manager quickly notices the room demarcation 30 representing the last room on the second floor. The larger third subarea of the room demarcation 30 is red indicating someone has set the room as inactive. The second subarea of the room demarcation 30 is white and there is a letter M inside of it indicating that the room requires maintenance. The third subarea of the room demarcation 30 also displays the letters KOV indicating to the manager that the room has a king-sized bed and an ocean view. When the manager last logged into the system 10 at 2 pm the room demarcation 30 was green indicating the room was available.

The last room of the second floor is indicated as room 209 by the room demarcation 30. When the wedding was booked, that the bride's parents specifically requested an ocean view. The manager scans the room demarcations 30 for the second floor and notices that the only other rooms currently unreserved or unoccupied for a reservation have the letters DDOV, or KCV in the third subarea. These letters indicate that these rooms have either an ocean view but two double-sized beds or a king-sized bed but a city view. The manager clicks on the calendar demarcation 38 for tomorrow. The system 10 updates the GUI 26 with the same calendar 28 but a new set of room demarcations 30 indicating the various items of room information 54 for tomorrow.

The manager then looks at the room demarcation 30 for room 209 and it indicates that the room is reserved. The manager hovers the mouse cursor over the third subarea of the room demarcation 30 representing room 209. The system 10 updates the display by overlaying room details 32 that indicate the bride and groom are the lodgers reserved for room 209. The manager then hovers the mouse cursor over the second subarea of the room demarcation 30 representing room 209 that still has the color white and has the letter M in it. The system 10 updates the display without the overlaid room details 32 indicating the bride and groom are the lodgers reserved for room 209. The system 10 also updates the display by now overlaying room details 32 indicating that there is no water pressure in the room. The property is relatively small and so maintenance is provided by contract with a third party maintenance staff that closes at 5 pm on Fridays. The manager calls at 4:03 pm and schedules the maintenance staff to fix room 209.

The maintenance staff arrives at 4:45 pm to fix the water pressure. The maintenance staff has a smartphone client that runs an instance of the system 10. The system 10 provides a display to the client with room demarcations 30. The room demarcation 30 representing room 209 has the color red in its third subarea and the color white in its second subarea with the letter M inside. The maintenance goes to room 209 and fixes the water pressure. At 5 pm, the maintenance staff uses the smartphone instance of the GUI 26 to alter the status of room 209 to indicate that the room no longer needs maintenance.

The manager looks at the display at 4:59 and clicks the calendar demarcation 38 for today. The system 10 provides an updated GUI 26 that simultaneously displays the calendar 28 and the plurality of room demarcations 30. The room demarcation 30 representing room 209 is still red indicating that the room is still inactive. The instance of the GUI 26 provided by the system 10 to the manager updates in real-time. At 5 pm the system 10 provides a GUI 26 with an updated room demarcation 30. Now the room demarcation 30 representing room 209 displays the following: the first subarea is tan with the letter C, the second subarea is green with the letter V, and the third subarea is also green with the letters KOV. The manager then updates the room status for room 29. The manager clicks on the room demarcation 30, and the system 10 provides an updated GUI 26 with room 209's details.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable storage medium with an executable program stored thereon for managing at least one property, wherein the property includes at least one room available for rent by a lodger for temporary lodging, wherein the program instructs a processing element to perform the following steps:
providing a graphical user interface (GUI) that is accessible by a user;
displaying, via the GUI, at least the following:
a calendar of a selected portion of time periods, wherein the calendar displays at least one calendar demarcation for each time period, and
a numerical indication of an occupancy status for each time period,
wherein the numerical indication identifies either (1) a number or a percentage of occupied rooms for the property and for the time period, or (2) a number or a percentage of non-occupied rooms for the property and for the time period,
wherein the numerical indication is visually displayed proximate the calendar demarcation for the time period, such that a user can visually associate the time period with the numerical indication of the occupancy status for the respective time period;
displaying, via the GUI and substantially contemporaneously with the calendar and numerical indication of the occupancy status, a plurality of room demarcations, wherein each room demarcation corresponds to one of said plurality of rooms for the property; and
displaying, via the GUI and substantially contemporaneously with the plurality of room demarcations, a plurality of items of room information for each one of said plurality of rooms,
wherein each item of room information for a respective room is visually displayed proximate the room demarcation for said respective room, such that the user can visually associate the plurality of items of room information with the respective room,
wherein each item of room information is identified via a coded identifier,
wherein for each item of room information, there is at least a first condition and a second condition of said item of room information,
wherein the coded identifier visually identifies to the user said first or said second condition for said item of room information.

2. The computer-readable storage medium of claim 1, wherein the program instructs the processing element to further perform the steps of:
receiving, from the user, a reservation request for one of said plurality of rooms for the property, wherein said reservation request includes a plurality of reservation data; and
generating an updated GUI in response to the receipt of the new reservation, wherein the updated GUI displays the room information for at least one of said plurality of rooms for the property corresponding to the reservation data for the new reservation.

3. The computer-readable storage medium of claim 2, wherein said plurality of items of room information includes a first item of room information and a second item of room information.

4. The computer-readable storage medium of claim 3,
wherein the first item of room information is a room status,
wherein said first condition for the room status is that the room is clean, and
wherein said second condition for the room status is that the room is dirty.

5. The computer-readable storage medium of claim 4,
wherein the coded identifier for identifying the first condition of the room status is a first color, and
wherein the coded identifier for identifying the second condition of the room status is a second color.

6. The computer-readable storage medium of claim 4,
wherein the coded identifier for identifying the first condition of the room status is a letter “C” for identifying the room as clean,
wherein the coded identifier for identifying the second condition of the room status is a letter “D” for identifying the room as dirty.

7. The computer-readable storage medium of claim 4,
wherein the coded identifier for identifying the first condition of the room status is both of a first color and a letter “C” for identifying the room as clean,
wherein the coded identifier for identifying the second condition of the room status is both of a second color and a letter “D” for identifying the room as dirty.

8. The computer-readable storage medium of claim 3,
wherein the second item of room information is the occupancy status of the room,
wherein said first condition of the occupancy status of the room is that the room is vacant,
wherein said second condition of the occupancy status of the room is that the room is occupied.

9. The computer-readable storage medium of claim 8,
wherein the coded identifier for identifying the first condition of the occupancy status of the room is a letter “V” for identifying the room as vacant,
wherein the coded identifier for identifying the second condition of the occupancy status of the room is a letter “O” for identifying the room as occupied.

10. The computer-readable storage medium of claim 3,
wherein the coded identifier for identifying the first condition of the occupancy status of the room is both of a first color and a letter “V” for identifying the room as vacant,
wherein the coded identifier for identifying the second condition of the occupancy status of the room is both of a second color and a letter “O” for identifying the room as occupied.

11. The computer-readable storage medium of claim 8, wherein the occupancy status of the room includes a third condition indicating that the room is undergoing or in need of maintenance.

12. The computer-readable storage medium of claim 3, wherein the plurality of items of room information includes a third item of room information, which is a size of at least one bed located in the room.

13. The computer-readable storage medium of claim 1, wherein the displayed plurality of room demarcations corresponds to a portion of the rooms for the property.

14. The computer-readable storage medium of claim 1, wherein the displayed plurality of room demarcations corresponds to all rooms for a particular building associated with the property.

15. The computer-readable storage medium of claim 1, wherein the displayed plurality of room demarcations corresponds to a building level on which the rooms are located.

16. The computer-readable storage medium of claim 1, wherein in addition to the numerical indication in each calendar demarcation, the GUI further displays in each calendar demarcation a first color if there are non-occupied rooms for the property for the time period, and a second color if all rooms are occupied for the property for the time period.

17. The computer-readable storage medium of claim 1, wherein each calendar demarcation for the time period is a day of the week or month, such that each day is its own individual demarcation.

18. The computer-readable storage medium of claim 1, wherein the program is further operable to instruct the processing element to perform the following steps:
receiving, from the user and via an input associated with the GUI, a request for additional information regarding a first room indicated by a first room demarcation;
displaying, via an updated GUI and substantially contemporaneously with the calendar and the plurality of room demarcations, a set of room details in response to the user's request for additional information, said set of room details providing additional information regarding said first room.

19. The computer-readable storage medium of claim 1, wherein the program is further operable to instruct the processing element to perform the following steps:
calculating an average daily rate (ADR) and a revenue per available room (REVPAR) for a pre-set time period and for at least a portion of the rooms of the property;
displaying, via the GUI and substantially contemporaneously with the calendar and the plurality of room demarcations, the calculated ADR and REVPAR for said pre-set time period; and
continuously calculating and displaying the calculated ADR and REVPAR for said pre-set time period in response to receiving changes in occupancy status for the property and for the pre-set time period.

20. A non-transitory computer-readable storage medium with an executable program stored thereon for managing at least two properties, wherein each property includes a plurality of rooms available for rent by a plurality of lodgers for temporary lodging, wherein the program instructs a processing element to perform the following steps:
receiving reservation information for at least a first room for each of the at least two properties, wherein the reservation information includes a rate paid for the first room;
calculating an average daily rate (ADR) for each of the at least two properties based on the received reservation information;
calculating a revenue per available room (REVPAR) for each of the at least two properties based on the received reservation information;
displaying, via a graphical user interface and to a user, the ADR and REVPAR;
receiving reservation information for at least a second room for each of the at least two properties;
calculating the ADR and the REVPAR for each of the at least two properties based on the received reservation information for at least the first and second room for each of the at least two properties; and
continuously updating the ADR and REVPAR for each of the at least two properties based on any subsequently-received reservation information for any of said plurality of rooms.
